(19) United States
(12) Patent Application Publication
(10) Pub. No.: US 2006/0222182 A1
(43) Pub. Date: Oct. 5, 2006

(54) Speaker system and sound signal reproduction apparatus

(76) Inventors: Shinichi Nakaishi, Kobe-shi (JP); Toshihiro Kido, Kobe-shi (JP)

Correspondence Address: CHRISTIE, PARKER & HALE, LLP, PO BOX 7068, PASADENA, CA, 91109-7068, US

(21) Appl. No.: 11/375,783

(22) Filed: Mar. 14, 2006

(30) Foreign Application Priority Data
Mar. 29, 2005 (JP) 2005-095635

(51) Int. Cl. H04R 5/00

(52) U.S. Cl. 381/27

(57) ABSTRACT

A plurality of speakers are installed at different positions in space and, of multichannel signals, only a center signal component is output from a speaker(s) mounted in at least one seat located within the space. The center signal component is output not only from the speaker(s) mounted in at least one seat, but also from a center speaker installed within the space. Further, the center signal component is reproduced by delaying it and outputting the delayed signal component from the speaker(s) mounted in at least one seat, thereby providing the precedence effect.

Applicant claims the right to priority based on Japanese Patent Application No. 2005-095635, filed on Mar. 29, 2005.

### BACKGROUND OF THE INVENTION

1. Field of the Invention

The present invention relates to a sound signal reproduction apparatus, and especially to a speaker system.

2. Description of the Related Art

In recent years, multichannel audio with multichannel music sources has been spreading to replace the traditional audio with two-channel music sources such as audio cassettes and CDs. Examples of such multichannel audio include a DVD that employs a discrete 6- or 8-channel digital surround system.

In the DVD digital surround system, the music source is recorded so as to be reproduced from six speakers suitably arranged in a room, that is, the music source is recorded on the disc by a discrete multichannel recording method for each of the six speakers. The six speakers in the DVD system are a center speaker, a front left speaker, a front right speaker, a rear left speaker, a rear right speaker, and a low frequency enhancement speaker (woofer). Of these speakers, the woofer reproduces low-frequency sound which is lower, for example, than 120 Hz; since this channel carries less information than the other channels that reproduce sounds up to 20 kHz, the six channels on such a DVD are called 5.1 channels.

For an automotive sound system, an automotive sound apparatus is disclosed that comprises a sound unit and a telephone unit wherein provisions are made so that, when an occupant is talking on the telephone unit, the sound signal such as music is reproduced only from a sound signal reproducing means such as a speaker mounted in the occupant's seat and the volume of the sound is reduced to such a level that is not audible to the other party of the line, thereby enabling the occupant to talk with the other party in a good condition while allowing the occupant to enjoy the music, etc. (JP05-191342A).

There is also disclosed an automotive sound system in which signals reproduced by a multichannel player from a source medium with three or more channels recorded thereon are processed according to the position of the listener seated inside the passenger compartment and the processed signals are added to the speakers corresponding to the respective channels, thereby enabling sound close to the original sound to be reproduced at the position of the listener (JP2000-341800A).

Further, there is disclosed an apparatus for controlling sound localization by using a head-related transfer function that indicates how a sound radiated from a sound source located in a prescribed position in space is transferred to the listener (JP06-261399A).

On the other hand, creating a simulated stereo signal from a monaural signal is a well known technique (JP11-146499A), and creating a surround signal from a stereo signal is also well known (JP10-066199A).

As described above, multichannel systems for automotive use have been finding widespread use in recent years, enabling people to enjoy sounds full of realism inside a vehicle as if they were in a movie theater. However, in the prior art automotive 5.1 multichannel surround system, sound such as actors' dialogue that comes from the center of the screen during playback of a movie or like DVD is often buried in the surround sound and becomes difficult to hear.

### SUMMARY OF THE INVENTION

The present invention provides a speaker system and a sound signal reproduction apparatus in which provisions are made to enhance the audibility of the sound, such as actors' dialogue, that comes from the center of the screen during playback of a movie or like material.

According to the speaker system and the sound signal reproduction apparatus of the present invention, a plurality of speakers are installed at different positions in space and, of the multichannel signals, only a center signal component is output from a speaker(s) mounted in at least one seat located within the space. This speaker(s) can be configured as a seat module speaker.

Further, of the multichannel signals, the center signal component is output not only from the speaker(s) mounted in at least one seat located within the space, but also from a center speaker mounted in a front portion.

Alternatively, of the multichannel signals, the center signal component is not only output from the speaker(s) mounted in at least one seat located within the space, but also divided between left and right front speakers for output therefrom.

According to the speaker system of the present invention, the center signal component is reproduced by delaying it and outputting the delayed signal component from the speaker(s) mounted in at least one seat, thereby providing the precedence effect. Further, the center signal component is delayed and its level reduced, and then output from the speaker(s) mounted in at least one seat.

Further, the center signal component is equalized, and the equalized signal component is output from the speaker(s) mounted in at least one seat.

According to the speaker system of the present invention, the center signal component is convolved with a head-related transfer function, and then output from the speaker(s) mounted in at least one seat.

Further, the frequency band of the center signal component is divided, and the higher frequency component is output from the center speaker, or is divided between the left and right front speakers for output therefrom, while the lower frequency component is output from the speaker(s) mounted in at least one seat.

Alternatively, the center signal component is output from the speaker(s) mounted in at least one seat, only when it is detected that the center signal component contains dialogue.

According to the present invention, as the center signal component is reproduced and output from the left and right auxiliary speakers mounted in the occupant seat, the occupant can clearly hear actors' dialogue contained in the center signal component when viewing a movie or the like in an automotive multichannel surround environment.

Further, as the precedence effect is provided when reproducing and outputting the center signal component from the center speaker and the auxiliary speakers mounted in the seat, the viewer viewing a movie or the like in the passenger compartment can clearly hear the dialogue, etc. spoken by a person in the center of the screen and output as the center signal component.

Further, by equalizing the center frequency component, the voice frequencies can be enhanced, which serves to enhance audibility without impairing the localization of the sound, such as dialogue, contained in the center signal component.

Further, by convolving the center signal component with the head-related transfer function that matches the physical features of the driver, for example, the center sound can be clearly localized while enhancing the clarify of the sound.

### BRIEF DESCRIPTION OF THE DRAWINGS

The above object and features of the present invention will be more apparent from the following description of the preferred embodiments with reference to the accompanying drawings, wherein:

FIG. 1A is a diagram showing the arrangement of speakers in a vehicle to which the present invention is applied;

FIG. 1B is a diagram showing the arrangement of speakers in the vehicle to which the present invention is applied;

FIG. 2 is a diagram showing the configuration of a speaker system according to the present invention;

FIG. 3 is a diagram showing a first embodiment of the speaker system according to the present invention;

FIG. 4 is a diagram showing a second embodiment of the speaker system according to the present invention;

FIG. 5 is a diagram showing a third embodiment of the speaker system according to the present invention;

FIG. 6 is a diagram showing how the frequency band of a center signal component is divided; and

FIG. 7 is a flowchart for explaining a ninth embodiment according to the present invention.

### DESCRIPTION OF THE PREFERRED EMBODIMENTS

The present invention will be described below by taking as an example the case where the present invention is applied to a vehicle.

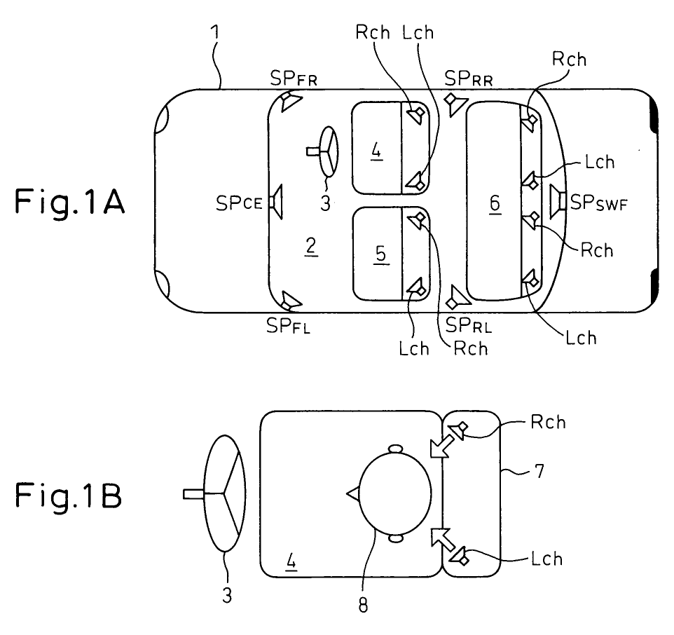

FIGS. 1A and 1B are diagrams showing the arrangement of speakers in the vehicle to which the present invention is applied. In FIG. 1A, reference numeral 1 is the vehicle, and the left side of the figure corresponds to the front of the vehicle. Reference numeral 2 is a passenger compartment, 3 is a steering wheel mounted inside the passenger compartment, 4 is a driver's seat located behind the steering wheel, 5 is a passenger seat located on the left side of the driver's seat, and 6 is a pair of rear seats located behind the driver's seat 4 and the passenger seat 5.

SP_{FL} and SP_{FR} are left and right front speakers mounted in the doors to the passenger seat 5 and the driver's seat 4, respectively, each speaker being oriented to face toward the passenger compartment 2, and SP_{RL} and SP_{RR} are left and right rear speakers mounted in the doors to the rear seats 6 and oriented to face toward the passenger compartment 2.

Further, SP_{CE} is a center speaker mounted in the instrument panel of the vehicle, and SP_{SWF} is a subwoofer mounted behind the rear seats 6.

L_{ch} and R_{ch} are left and right auxiliary speakers mounted in the driver's seat, the passenger seat, and the rear seats; the speakers are mounted in the head rest of each seat.

FIG. 1B shows an example of the arrangement of the auxiliary speakers L_{ch} and R_{ch} in the driver's seat 4; as shown, the speakers are mounted in the left and right sides of the head rest 7 of the seat for the driver 8 and pointed toward the head of the driver 8.

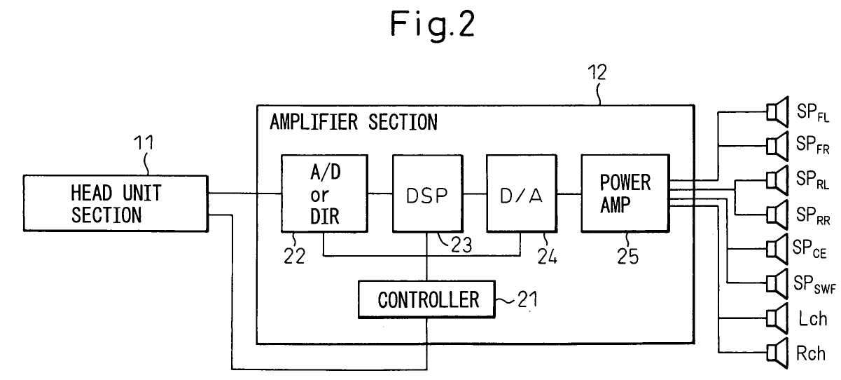

FIG. 2 shows the configuration of the speaker system according to the present invention; as shown, the speaker system comprises a head unit section 11, an amplifier section 12, and a speaker section. The head unit section 11 comprises, for example, a DVD player with a monitor, a navigation apparatus, etc., and outputs multichannel signals to the amplifier section 12.

The amplifier section 12 comprises a controller 21, an A/D converter or a DIR (Digital Interface Receiver) 22, a DSP (Digital Signal Processor) 23, a D/A converter 24, and a power amplifier 25.

The left and right front speakers SP_{FL} and SP_{FR}, the left and right rear speakers SP_{RL} and SP_{RR}, the center speaker SP_{CE}, the subwoofer SP_{SWF}, and the left and right auxiliary speakers L_{ch} and R_{ch} mounted in each seat are connected to the power amplifier 25.

### First Embodiment

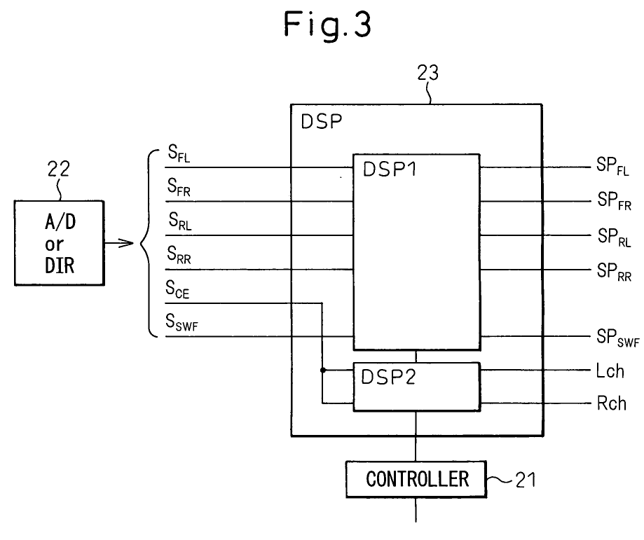

FIG. 3 shows a first embodiment of the speaker system according to the present invention, illustrating how the multichannel signals from the head unit 11 are delivered via the DSP 23 to the respective speakers for reproduction. In FIG. 3, the D/A converter 24 and the power amplifier 25 are not shown.

In FIG. 3, front signal components S_{FL} and S_{FR} are signal components to be reproduced and output from the left and right front speakers, and rear signal components S_{RL} and S_{RR} are signal components to be reproduced and output from the left and right rear speakers. A center signal component S_{CE} is a signal component which, in the case of a movie or the like, mainly contains the voice of a person or the like located in the center of the screen, and S_{SWF} is a subwoofer signal component to be output from the subwoofer SP_{SWF}.

As shown in FIG. 3, the center signal component S_{CE} is reproduced and output from the left and right auxiliary speakers L_{ch} and R_{ch} via a DSP 2. In the case of a movie, the center signal component S_{CE} represents the dialogue spoken by a person substantially centralized on the screen, and this voice signal constitutes the center signal component S_{CE}; therefore, by reproducing and outputting this signal component from the auxiliary speakers L_{ch} and R_{ch} mounted in the head rest, the dialogue can be clearly heard from the auxiliary speakers L_{ch} and R_{ch} when the viewer is viewing a movie or the like under a multichannel surround environment, even when there is no center speaker.

### Second Embodiment

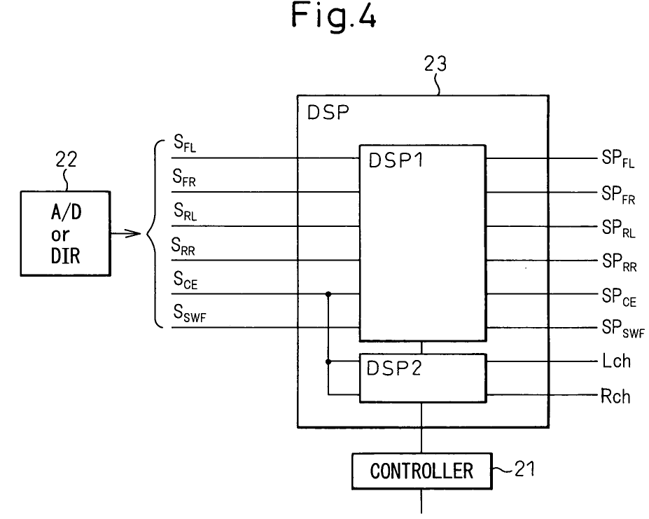

FIG. 4 shows a second embodiment of the speaker system according to the present invention, the difference from the first embodiment shown in FIG. 3 being that the center signal component S_{CE} is not only reproduced and output from the left and right auxiliary speakers L_{ch} and R_{ch} via the DSP 2 but, at the same time, reproduced and output from the center speaker SP_{CE} via a DSP 1.

In this way, in the case of a movie or the like, as the center signal component S_{CE} representing the dialogue spoken by a person substantially centralized on the screen is reproduced and output from the center speaker SP_{CE} as well as from the left and right auxiliary speakers L_{ch} and R_{ch}, the viewer can hear the dialogue not only from the auxiliary speakers L_{ch} and R_{ch} but also from the center speaker SP_{CE} when viewing the movie or the like under an automotive multichannel surround environment; as a result, the viewer can hear the dialogue clearly.

### Third Embodiment

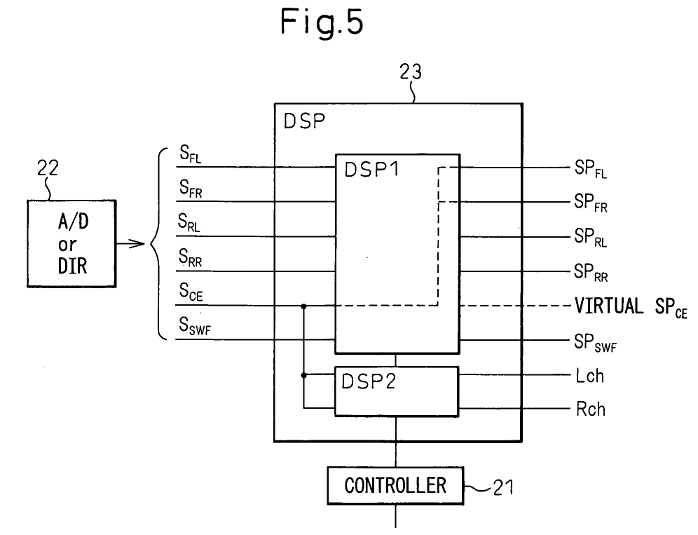

FIG. 5 shows a third embodiment of the speaker system according to the present invention, the difference from the first embodiment shown in FIG. 3 being that the center signal component S_{CE} is not only reproduced and output from the left and right auxiliary speakers L_{ch} and R_{ch} via the DSP 2 but, at the same time, is divided between the left and right front speakers SP_{FL} and SP_{FR} and reproduced and output from them via the DSP 1.

As the center signal component S_{CE} is divided between the left and right front speakers SP_{FL} and SP_{FR} and reproduced and output from these two speakers as described above, the same effect as if a virtual center speaker SP_{CE} was present can be provided to the listener, though the center speaker SP_{CE} is not provided.

As a result, when viewing a movie or the like under an automotive multichannel surround environment, the viewer can hear the sound not only from the auxiliary speakers L_{ch} and R_{ch} but also from the virtual center speaker SP_{CE} and, thus, the viewer can hear the dialogue clearly.

### Fourth Embodiment

When identical sounds are radiated from a plurality of sound sources, the sound will be localized in the direction of the sound source that provides the sound that first arrives at the listener's ear; this phenomenon is called the precedence effect or the Haas effect.

When there are two sound sources, if the time difference between the arrivals of the two sounds is, for example, 1 ms or less, the precedence effect does not occur. Further, if the second sound is sufficiently stronger than the first sound, for example, if the second sound is stronger than the first sound by 10 to 15 dB, the precedence effect does not occur because the first arriving sound is overwhelmed by the subsequently arriving sound.

The fourth embodiment of the present invention provides a speaker system that utilizes the precedence effect (or the Haas effect); that is, in the second and third embodiments shown in FIGS. 4 and 5, this is accomplished by delaying the center signal component S_{CE} in the DSP 2 and by reproducing and outputting the thus delay sound from the auxiliary speakers L_{ch} and R_{ch.}

In FIG. 4, the controller 21 controls the DSP 2 so that the center signal component S_{CE} is delayed in the DSP 2 and the thus delayed sound is reproduced and output from the auxiliary speakers L_{ch} and R_{ch}. As the center signal component S_{CE} is also reproduced and output from the center speaker SP_{CE} via the DSP 1, the center signal component S_{CE} is reproduced and output from two sound sources, that is, the center speaker SP_{CE} and the auxiliary speakers L_{ch} and R_{ch}. In the present embodiment, as the center signal component S_{CE} is delayed in the DSP 2 and the delayed sound is reproduced and output from the auxiliary speakers L_{ch} and R_{ch}, the sound from the center speaker SP_{CE} arrives earlier at the listener's ear, and thus, the precedence effect occurs. As a result, the sound coming from the direction of the center speaker SP_{CE} is heard clearly, and thus the clarity of the sound is enhanced while maintaining the direction of the sound localized to the front.

In the above description, the center signal component S_{CE} is delayed in the DSP 2 and the delayed sound is reproduced and output from the auxiliary speakers L_{ch} and R_{ch}, but if the second sound is stronger than the first sound, the first sound will be overwhelmed by the second sound, and the precedence effect will not occur; in view of this, the center signal component S_{CE} is not only delayed but its level is also reduced in the DSP 2 and the delayed sound whose level is thus reduced is reproduced and output from the auxiliary speakers L_{ch} and R_{ch} so that the precedence effect can be sufficiently obtained.

As the precedence effect is provided as described above when reproducing and outputting the center signal component S_{CE} from the center speaker SP_{CE} and the auxiliary speakers L_{ch} and R_{ch}, the viewer viewing a movie or the like in the passenger compartment can clearly hear the dialogue, etc. spoken by a person in the center of the screen and output as the center signal component.

Further, in the fourth embodiment, by controlling the DSP 2 from the controller 21, the precedence effect can be turned on and off by turning on and off the function to delay and reduce the level of the center signal component S_{CE}.

In the third embodiment shown in FIG. 5, as the center signal component S_{CE} is not only delivered via the DSP 2 to the left and right auxiliary speakers L_{ch} and R_{ch} but, at the same time, delivered via the DSP 1 to the left and right front speakers SP_{FL} and SP_{FR} by being divided between them, the same effect as if the virtual center speaker SP_{CE} was present in the front portion of the passenger compartment can be obtained.

In this case also, if the center signal component S_{CE} is delayed in the DSP 2 by controlling the DSP 2 from the controller 21 and the delay sound is reproduced and output from the auxiliary speakers L_{ch} and R_{ch}, the same effect can be obtained as when the center signal component S_{CE} was reproduced and output from a plurality of sound sources, i.e., the virtual center speaker SP_{CE} and the auxiliary speakers L_{ch} and R_{ch}. In this case, since the center signal component S_{CE} is delayed in the DSP 2 and the delay sound is reproduced and output from the auxiliary speakers L_{ch} and R_{ch}, the sound from the virtual center speaker SP_{CE} arrives earlier at the listener's ear, and as a result, the sound coming from the direction of the virtual center speaker SP_{CE} is heard clearly, and the clarity of the sound is thus enhanced while maintaining the direction of the sound localized to the front.

In the case of FIG. 5 also, the precedence effect can be sufficiently obtained by delaying the center signal component S_{CE} and reducing its level in the DSP 2 and by reproducing and outputting the delayed and reduced sound from the auxiliary speakers L_{ch} and R_{ch}.

In the fourth embodiment, by providing the precedence effect as described above, the clarity of the sound can be enhanced without impairing the localization of the sound, such as dialogue, contained in the center signal component.

### Fifth Embodiment

In the fifth embodiment, provisions are made in the first, second, and third embodiments shown in FIGS. 3, 4, and 5 so that the center signal component S_{CE} is equalized in the DSP 2 and the thus equalized sound is reproduced and output from the auxiliary speakers L_{ch} and R_{ch}.

For example, the center signal component S_{CE} is reproduced and output from the auxiliary speakers L_{ch} and R_{ch} via a band-pass filter (BPF). A BPF having a pass band of 300 Hz to 3 kHz, that passes the voice frequencies is used as the BPF here. Alternatively, a parametric equalizer may be used. By applying the equalization in this manner, the voice frequencies can be enhanced, enhancing the clarity of the sound without impairing the localization of the sound, such as dialogue, contained in the center signal component.

Here, the DPS 2 can be controlled from the controller 21 to determine whether to apply or not apply the equalization.

### Sixth Embodiment

In the fourth embodiment, it has been shown how the precedence effect can be utilized but, in addition to providing the precedence effect, the equalization may be applied by controlling the DSP 2; in that case, the clarity of the sound can be enhanced without impairing the localization of the sound reproduced from the center signal component, such as the dialogue spoken by a person located in the center of the screen, when playing back a movie or the like.

### Seventh Embodiment

The head-related transfer function varies depending on the physical features of the listener, such as the shapes of the listener's head and pinnae. For example, a sound coming straight on toward the front of the face first strikes the nose where the sound is split between left and right, and the thus split sound is transmitted through the cheekbones and reflected by the pinnae into the ears; therefore, a sound coming from the front is influenced by the shapes of the nose and the cheekbones. On the other hand, a sound coming from the 90-degree side direction is not influenced by the shapes of the nose and the cheekbones, but is influenced by the shape of the pinnae. Further, a sound coming from behind the head first strikes the back of the head where the sound is split between left and right, and the thus split sound then travels over the pinnae and enters the ears. In this way, the head-related transfer function differs depending on the listener's head shape, etc.

In the present invention, in the DSP 2 of FIGS. 4 and 5, the center signal component S_{CE} to be reproduced and output from the auxiliary speakers L_{ch} and R_{ch} is convolved, for example, with the head-related transfer function (HRTF) that matches the physical features of the driver, to bring the virtual sound source produced by the auxiliary speakers closer to the front center position. By the convolution with the head-related transfer function (HRTF), the sound from the auxiliary speakers can be heard as if it is coming from the direction of the center speaker SP_{CE} or the virtual center speaker, and thus the center sound can be clearly localized while enhancing the clarify of the sound.

It is also possible to obtain the head-related transfer function that matches a passenger other than the driver, and to convolve the center signal component S_{CE} to be reproduced and output from the auxiliary speakers L_{ch} and R_{ch} with the thus obtained head-related transfer function. In cases where the HRTF that matches the physical features of the driver or the passenger cannot be prepared, an HRTF obtained using a dummy head is used instead.

In that case, HRTFs that respectively match a number of typical head shapes may be prestored so that the user can select an HRTF that matches him or her from among the prestored HRTFs. That is, since the head shapes can be roughly classified into several types based on the race, age, sex, etc., HRTFs based on a number of average head shapes are prestored for each race, age, and sex, and the user, while switching from one HRTF to another, selects the HRTF that achieves clear localization in the center direction; in this way, the user can select the HRTF that matches the user's physical features.

### Eighth Embodiment

The frequency band of the center signal component is divided, and the higher frequency component is reproduced and output from the front center speaker SP_{CE} or the virtual center speaker, while the lower frequency component is reproduced and output from the auxiliary speakers L_{ch} and R_{ch}.

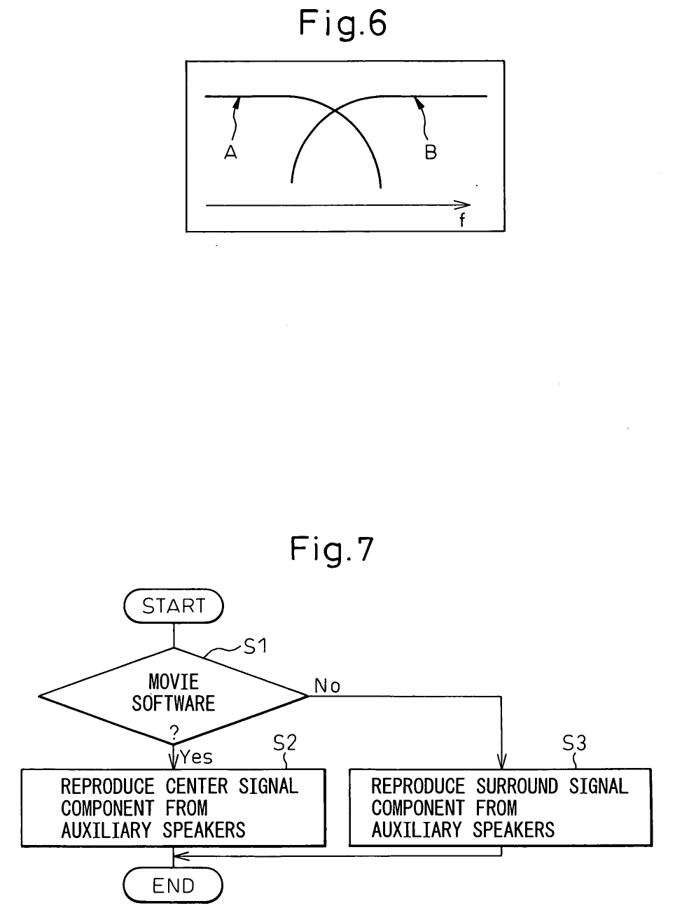

FIG. 6 is a diagram showing the frequency band divided between the respective speakers; here, the lower frequency component indicated by A is reproduced and output from the auxiliary speakers L_{ch} and R_{ch} , and the higher frequency component indicated by B is reproduced and output from the front center speaker SP_{CE} or the virtual center speaker.

When the higher frequency component whose direction can be easily localized is reproduced from the front center speaker as described above, the size of the center speaker can be reduced while maintaining the front localization of the center signal component.

### Ninth Embodiment

In each of the above embodiments, the auxiliary speakers have been provided so that the dialogue primarily contained in the center signal component can be clearly heard especially in the case of movie software; however, in the case of music DVD or the like in which the center signal component does not contain dialogue, there is no need to reproduce and output the center signal component from the auxiliary speakers. Accordingly, provisions may be made to determine whether the software to be played back is movie software or not, and to reproduce and output the center signal component from the auxiliary speakers only when the software is movie software.

FIG. 9 is a flowchart for explaining the ninth embodiment of the present invention.

First, when playing back the software, it is determined whether the software is movie software or not (S1). Whether the software is movie software or not is determined, for example, in the following manner.

(1) The determination is made by the user performing an operation such as a key input or voice recognition.

(2) The determination is made based on the format of the reproduced sound. For example, in the case of AC3, DTS, or the like, it is determined that the software is movie software, but in the case of linear PCM, it is determined that the software is live video or music software.

(3) The determination is made based on the type of the played back disc. For example, in the case of DVD-Video, it is determined that the software is movie software, but in the case of DVD-Audio, SACO, CD, or DTS-CD, it is determined that the software is live video or music software.

(4) The title information recorded on the disc is matched against a database to determine whether the software is movie software or not.

(5) The determination is made by utilizing the information recorded when the disc was previously played back. For example, for any disc that has ever been played back before, information such as the title information that can identify the disc is recorded on a HDD or the like by associating the information with the sound output mode at that time, and when the disc is played back next time, the output mode is automatically reproduced.

If it is determined in S1 that the software is movie software (Yes), the center signal component is reproduced and output from the speakers mounted in each seat (S2).

On the other hand, if it is not determined in S1 that the software is movie software (No), then the surround signal component, for example, is reproduced and output from the speakers mounted in each seat (S3). Instead, the outputs from the speakers mounted in each seat may be turned off, or the main signal component may be output from them.

In each of the above embodiments, of the multichannel signals the center signal component is reproduced and output from the speakers mounted in each seat but, in the case of movie or like software, dialogue may not always be contained in the center signal component. Therefore, provisions may be made to detect a signal component containing dialogue from among the multichannel signals, and to reproduce and output that signal component from the speakers mounted in the plurality of seats.

The description so far has been given on the assumption that multichannel audio signals such as 6 channels (5.1 channels) are recorded on the medium such as a DVD, but actually there are media on which only two-channel stereo signals are recorded or which are recorded in monaural.

A method for reproducing such an audio source on a multichannel speaker system, that is, a method for artificially creating a 5.1-channel signal from a two-channel signal or a monaural signal, is well known (refer to JP11-146499A and JP10-66199A), and it will be appreciated that the present invention can also be applied when reproducing a multichannel signal artificially generated by such a method.

For example, in the embodiments described with reference to FIGS. 4 and 5, a 5.1-channel signal artificially generated from a two-channel signal or a monaural signal is input to the DSP 23 and reproduced from the speakers.

The present invention has been described by taking an automotive speaker system and sound reproduction apparatus as an example, but it will be appreciated that the present invention is not limited to automotive applications.

What is claimed is:

1. A speaker system which outputs multichannel signals from a plurality of speakers installed at different positions in space, comprising:
a speaker(s) mounted in at least one seat located within said space, and wherein
of said multichannel signals, only a center signal component is output from said speaker(s).

2. A speaker system as claimed in claim 1, wherein
said plurality of speakers include a center speaker mounted in a front portion within said space, and
said center signal component is output from said center speaker.

3. A speaker system as claimed in claim 1, wherein
said plurality of speakers include left and right front speakers mounted in a front left portion and a front right portion, respectively, within said space, and
said center signal component is divided between said left and right front speakers for output therefrom.

4. A speaker system as claimed in claim 1, wherein said center signal component is delayed, and said delay signal component is output from said speaker(s) mounted in said at least one seat.

5. A speaker system as claimed in claim 1, wherein said center signal component is delayed and its level reduced, and said delayed and reduced signal component is output from said speaker(s) mounted in said at least one seat.

6. A speaker system as claimed in claim 1, wherein said center signal component is equalized, and said equalized signal component is output from said speaker(s) mounted in said at least one seat.

7. A speaker system as claimed in claim 1, wherein said center signal component is band-pass filtered, and said band-pass filtered signal component is output from said speaker(s) mounted in said at least one seat.

8. A speaker system as claimed in claim 1, wherein said center signal component is delayed and band-pass filtered, and said delayed and band-pass filtered signal component is output from said speaker(s) mounted in said at least one seat.

9. A speaker system as claimed in claim 1, wherein said center signal component is convolved with a head-related transfer function and output from said speaker(s) mounted in said at least one seat.

10. A speaker system as claimed in claim 2, wherein
a high-frequency component of said center signal component is output from said center speaker, and
a low-frequency component of said center signal component is output from said speaker(s) mounted in said at least one seat.

11. A speaker system as claimed in claim 3, wherein
a high-frequency component of said center signal component is output from said front speakers, and
a low-frequency component of said center signal component is output from said speaker(s) mounted in said at least one seat.

12. A speaker system as claimed in claim 1, wherein said speaker(s) mounted in said seat is a seat module speaker.

13. A speaker system as claimed in claim 1, wherein when it is determined that said multichannel signals are from movie software, then said center signal component is output from said speaker(s) mounted in said at least one seat.

14. A speaker system as claimed in claim 1, wherein when it is determined that said multichannel signals are not from movie software, then surround signal component or a main signal component is output from said speaker(s) mounted in said at least one seat.

15. A speaker system as claimed in claim 1, wherein said multichannel signals are multichannel signals, containing at least a center frequency component, that are generated from a monaural signal or a two-channel stereo signal.

16. A speaker system which outputs multichannel signals from a plurality of speakers installed at different positions in space, comprising:
a speaker(s) mounted in at least one seat located within said space, and wherein
of said multichannel signals, only a signal component containing dialogue is output from said speaker.

17. A sound signal reproduction apparatus which outputs multichannel signals to a plurality of speakers installed at different positions in space, wherein
of said multichannel signals, only a center signal component is output from a speaker(s) mounted in at least one seat located within said space.

18. A sound signal reproduction apparatus as claimed in claim 17, wherein said multichannel signals are multichannel signals, containing at least a center frequency component, that are generated from a monaural signal or a two-channel stereo signal.

19. A sound signal reproduction apparatus which outputs multichannel signals to a plurality of speakers installed at different positions in space, wherein
of said multichannel signals, only a signal component containing dialogue is output from a speaker(s) mounted in at least one seat located within said space.
